(19) United States
(12) Patent Application Publication
(10) Pub. No.: US 2022/0261206 A1
(43) Pub. Date: Aug. 18, 2022

(54) SYSTEMS AND METHODS FOR CREATING USER-ANNOTATED SONGCASTS

(71) Applicant: Meta Platforms, Inc., Menlo Park, CA (US)

(72) Inventor: Debashish Paul, Sunnyvale, CA (US)

(21) Appl. No.: 16/789,798

(22) Filed: Feb. 13, 2020

(51) Int. Cl. G06F 3/16; G06F 40/169; G06F 3/0482

(52) U.S. Cl. CPC G06F 3/16; G06F 3/0482; G06F 40/169

(57) ABSTRACT

A computer-implemented method for user-annotated songcasts may include (i) displaying, to a user, a songcast creation interface that enables the user to create a songcast, (ii) receiving, via the songcast creation interface, identification of a group of audio media items to be included in the songcast and at least one user-created annotation about the audio media items, (iii) creating the songcast in response to receiving the identification of the audio media items and the user-created annotation about the audio media items, (iv) displaying, via a songcast display interface, the songcast to an additional user, and (vi) playing, via the songcast display interface, the songcast for the additional user by playing at least one of the audio media items associated the songcast and simultaneously displaying the user-created annotation about the audio media items. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for creating user-annotated songcasts.

FIG. 2 is a flow diagram of an exemplary method for creating user-annotated songcasts.

FIG. 3 is an illustration of an exemplary songcast creation interface.

FIG. 4 is an illustration of an exemplary songcast display interface.

FIG. 5 is a timeline of elements displayed in a songcast display interface.

FIG. 6 is an illustration of an exemplary songcast landing page.

FIG. 7 is an illustration of an exemplary media landing page.

Throughout the drawings, identical reference characters and descriptions indicate similar, but not necessarily identical, elements. While the exemplary embodiments described herein are susceptible to various modifications and alternative forms, specific embodiments have been shown byway of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

Many applications and services exist for streaming and discovering music. Nonetheless, one of the largest drivers of music discovery remains personal recommendation from friends and acquaintances. The present disclosure is generally directed to systems and methods for enabling users to share music (via, e.g., a social networking platform and/or music discovery service) with their own descriptions, annotations, and/or other information added. In some examples, these “songcasts” may include multiple songs and/or user-created media, such as video or audio clips in which a user describes their feelings about the song. As will be explained in greater detail below, by enabling users to curate custom lists of media with their own annotations and descriptions, the systems and services described herein may facilitate the sharing (and discovery) of media between users and their friends. In some cases, these systems may also enable celebrities to promote media by other artists, creating an additional avenue of media discovery for users.

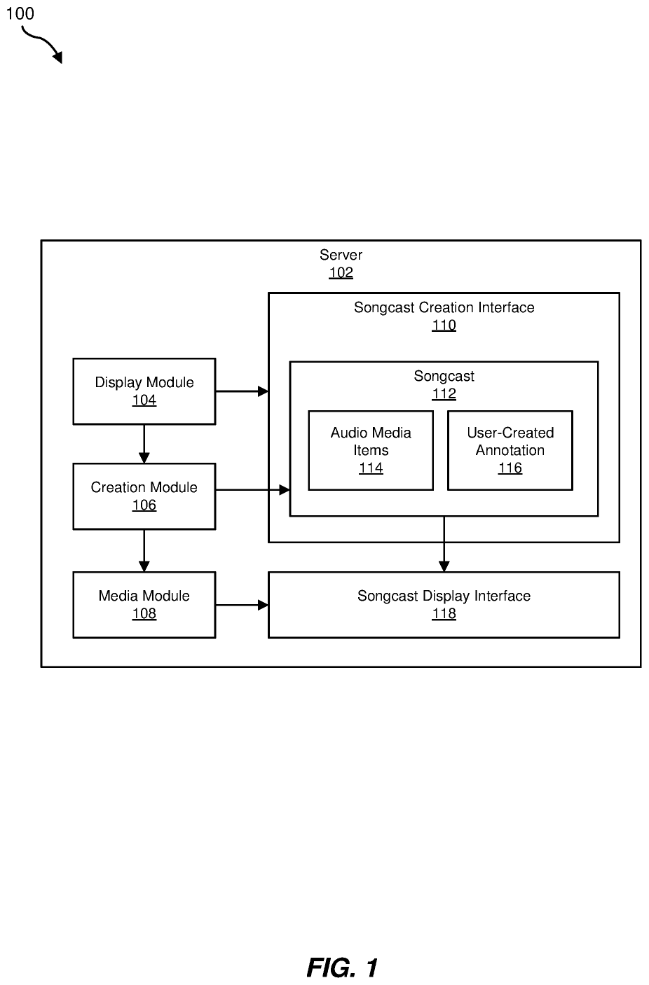

In some embodiments, the systems described herein may be hosted on one or more servers. FIG. 1 is a block diagram of an exemplary system 100 for creating user-annotated songcasts. In one embodiment, and as will be described in greater detail below, a server 102 may be configured with a display module 104 that displays, to a user, a songcast creation interface 110 that enables the user to create a songcast 112. Although illustrated as a single element, in some embodiments server 102 may represent multiple physical and/or virtual servers hosted in the same and/or different locations (e.g., cloud servers). Example system 100 may also include a creation module 106 that (1) receives, via songcast creation interface 110, the identification of audio media items 114 to be included in songcast 122 and at least one user-created annotation 116 about audio media items 114 and then (2) creates the songcast in response to receiving the identification of audio media items 114 and user-created annotation 116. Example system 100 may additionally include a media module 108 that displays, via a songcast display interface 118, the songcast 112 for an additional user and plays at least one of the audio media items 114 associated with songcast 112 while simultaneously displaying user-created annotation 116. Although illustrated as separate elements, one or more of the modules in FIG. 1 may represent portions of a single module or application.

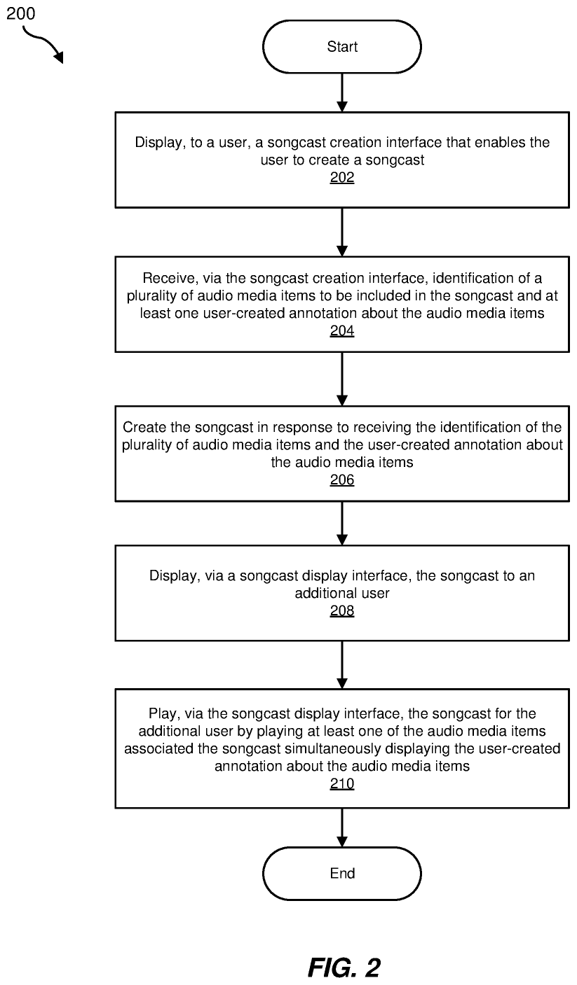

FIG. 2 is a flow diagram of an exemplary method 200 for creating user-annotated songcasts. In some examples, at step 202, the systems described herein may display, to a user, a songcast creation interface that enables the user to create a songcast. For example, display module 104 may, as part of server 102 in FIG. 1, display, to a user, a songcast creation interface 110 that enables the user to create a songcast 112.

The term “songcast,” as used herein, may generally refer to any collection of media items with associated user-created annotations. As will be explained in greater detail below, a songcast may include text describing the entire songcast and/or individual songs. In addition, a songcast may enable other users to leave public and/or private comments about the songcast and/or individual songs in the songcast. In one example, a songcast may include an ordered list of songs, each of which has a user-created annotation that describes the user's feelings about the song. A songcast may also include a user-created annotation that is associated with the songcast as a whole. In one example, a songcast may have user-created annotations for some media items but not others. In addition, a songcast may include user-created audio media items that are interspersed with the non-user-created audio media items in an ordered list. A songcast may also include audio media items that are not songs, such as podcasts, videos, readings of written media, and/or any other type of audio media. In one embodiment, a songcast may include audio media items of the same type of media (e.g., all songs, all videos, etc.), while in other embodiments one songcast may include audio media items of multiple types. As detailed below, a corresponding songcast display interface may include a header, a station story, station playback, a marquee song story, a music layer entry, a private feedback form, and/or navigation tools.

Display module 104 may display the songcast creation interface in a variety of ways and/or contexts. For example, display module 104 may display the songcast creation interface via a mobile device, such as a smartphone. Additionally or alternatively, display module 104 may display the songcast creation interface via a desktop computing device. In some embodiments, display module 104 may display the songcast creation interface as a web page viewable with a web browser. Additionally or alternatively, display module 104 may display the songcast creation interface as part of an application. In some embodiments, the songcast creation interface may be part of a larger media application, such as a music streaming service and/or a social networking platform. In one embodiment, the songcast creation interface may be part of a dedicated application for creating, sharing, and/or viewing songcasts.

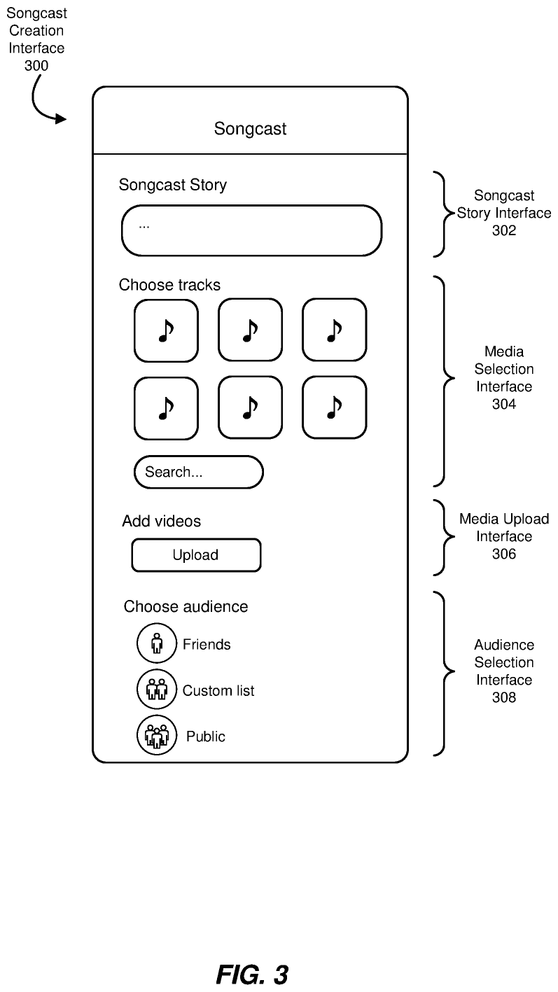

In some embodiments, a songcast creation interface may be multiple pages and/or layers in a web site and/or application. In one embodiment, the systems described herein may display a songcast creation interface on a single page and/or layer. For example, as illustrated in FIG. 3, a songcast creation interface 300 may include a songcast story interface 302, a media selection interface 304, a media upload interface 306, and/or an audience selection interface 308. In some embodiments, songcast story interface 302 may enable the user to enter a description and/or annotation that applies to the entire songcast and/or is visible while any audio media item in the songcast is played. In one embodiment, media selection interface 304 may enable a user to select audio media items for inclusion in the songcast.

In some examples, the term “audio media item” or “media,” as used herein, may generally refer to audio files and/or any type of image, video, animation, and/or combination thereof that includes audio. In some embodiments, an audio media item may be a song or a portion of a song. Additionally or alternatively, an audio media item may be a video (or a portion of a video), such as a music video. In some embodiments, media selection interface 304 may enable a user to search a library and/or catalogue of audio media items. In one example, media selection interface 304 may enable a user to search a collection of audio media items curated by the user. In one embodiment, media selection interface 304 may enable a user to specify an order of the audio media items in the songcast. In some examples, media selection interface 304 may enable the user to add annotations related to an audio media item once the audio media item has been selected. The term “annotation,” as used here, may generally refer to any text, graphic, animation, link, audio, video, and/or combination thereof that describes and/or is associated with another object. For example, an annotation may include a written description of a piece of media, an image related to the piece of media and/or a link to further information about the piece of media. In some examples, a user may create an annotation that describes the user's feelings about the audio media item. In one example, a user may create a songcast annotation that is relevant to the entire songcast and/or a media-specific user-created annotation that is relevant to and/or associated with a single media item in the songcast.

In some embodiments, media upload interface 306 may enable a user to upload user-created media, such as audio and/or video, for inclusion into the songcast. For example, media upload interface 306 may enable a user to upload a video explaining their personal connection to a song in the songcast. In some examples, media upload interface 306 may also enable the user to add annotations to the user-created media. In one embodiment, audience selection interface 308 may enable a user to specify an audience for the songcast. For example, a songcast may be public (i.e., viewable by all users of a platform), viewable by a user's friend list, and/or viewable by a custom list of users. Examples of custom lists of users may include a specified subset of a user's friend list, a pre-existing group of users (e.g., an interest-based group, a geographic group, etc.), and/or any other type of custom list of users of a platform and/or service. For example, a user may create one songcast that is viewable by the public, another songcast that is viewable by the user's family, and/or a third songcast that is viewable by the user's high school friends.

Returning to FIG. 2, at step 204, one or more of the systems described herein may receive, via the songcast creation interface, identification of audio media items to be included in the songcast and at least one user-created annotation about the audio media item. For example, receiving module 106 may, as part of server 102 in FIG. 1, receive, via songcast creation interface 110, identification of audio media items 144 to be included in songcast 112 and at least one user-created annotation 116 about audio media items 114.

Receiving module 106 may receive identification of the audio media items in a variety of ways. For example, receiving module 106 may receive a set of pointers to a database location where the audio media items are stored from an interface that converts user selections (e.g., of images representing the audio media items) into pointers. In another example, receiving module 106 may receive text that describes the audio media items (e.g., title, artist, album, etc.) and may then locate the audio media items based on the text description. In one example, receiving module 106 may receive a list of uniform resource locators (URLs) of web pages that host the audio media items.

In some examples, receiving module 106 may receive user-created annotations about one or more audio media items in the songcast. For example, receiving module 106 may receive text and/or images that describe a user's feelings about an audio media item. In another example, receiving module 106 may receive text and/or a hyperlink that includes more information about the audio media item (e.g., history, cultural relevance, further information about the artist, etc.). In some embodiments, receiving module 106 may receive media uploaded by the user for inclusion in the annotation, such as an image that is relevant to the audio media item.

In one embodiment, receiving module 106 may receive, via the songcast creation interface, an item of user-created audio media to be included in the songcast. For example, receiving module 106 may receive a video of the user talking about the emotional impact of one of the songs in the songcast. In another example, receiving module 106 may receive a song recorded by the user. In some embodiments, receiving module 106 may receive user-created audio media by receiving an uploaded file. Additionally or alternatively, receiving module 106 may receive a link and/or reference to the user-created audio media item.

In one embodiment, receiving module 106 may receive an ordered list of the audio media items. For example, the songcast display interface may include a graphical user interface (GUI) that enables a user to arrange media items into a particular order. In some examples, receiving module 106 may receive an ordered list of audio media items selected by the user interspersed with user-created media items. In one example, receiving module 106 may receive a list of songs and videos of a user discussing the songs.

In some examples, receiving module 106 may receive a selection of an audience of additional users who are permitted to view the songcast. For example, receiving module 106 may receive one or more criteria for evaluating whether a user is permitted to view the songcast (e.g., is the user a friend of the creator of the songcast, is the user a member of a specific group, etc.). In another example, receiving module 106 may receive a list of references to accounts of users who are permitted to view the songcast.

At step 206, one or more of the systems described herein may create the songcast in response to receiving the identification of the plurality of audio media items and the user-created annotation about the audio media items. For example, creation module 106 may, as part of server 102 in FIG. 1, create songcast 112 in response to receiving the identification of audio media items 114 and user-created annotation 116 about audio media items 114.

Creation module 106 may create the songcast in a variety of ways and/or contexts. For example, creation module 106 may store the information about the various components of the songcast (e.g., ordered list of media, annotations, audience, etc.) on a server and/or in a database. In some embodiments, creation module 106 may create a reference to the songcast that is accessible to the user for the purposes of editing the songcast after creation.

At step 208, one or more of the systems described herein may display, via a songcast display interface, the songcast to an additional user. For example, media module 108 may, as part of server 102 in FIG. 1, display, via songcast display interface 118, songcast 112 to an additional user.

Media module 108 may display the songcast to the additional user in a variety of ways and/or contexts. For example, media module 108 may display the songcast display interface on a web page in a web browser tab. Additionally or alternatively, media module 108 may display the songcast display interface via an application (e.g., a smartphone app). In some embodiments, media module 108 may only display the songcast to users who are part of a selected audience of users who are permitted to view the songcast (e.g., the creator's friends, members of a user-defined group, etc.) and/or may avoid displaying the songcast to users who are not part of the audience for the songcast.

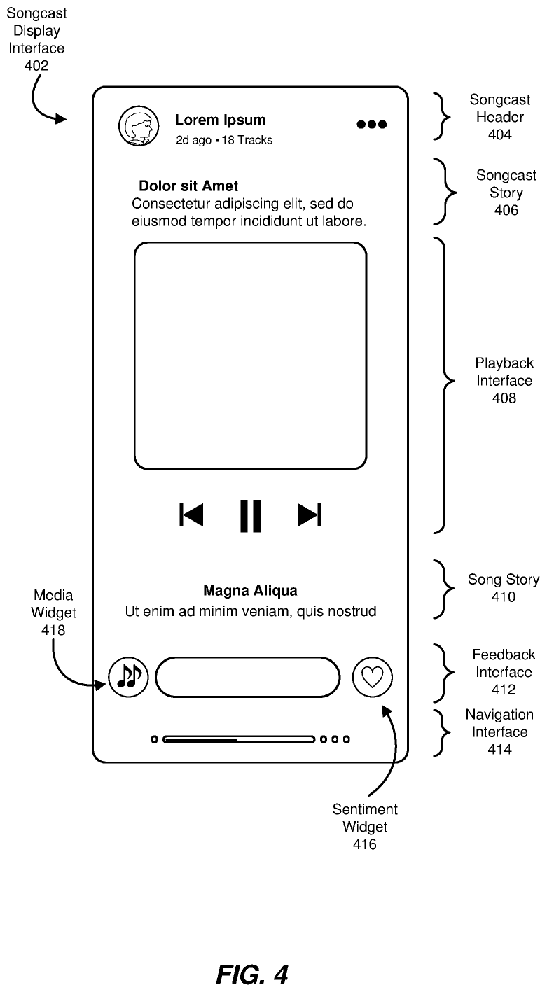

In some embodiments, a songcast display interface may include various components that facilitate engagement with the audio media items. For example, as illustrated in FIG. 4, a songcast display interface 402 may include a songcast header 404, a songcast story 406, a playback interface 408, a song story 410, a feedback interface 412, a navigation interface 414, a sentiment widget 416, and/or a media widget 418. In some examples, songcast header 404 may include information about the songcast such as the name and/or profile image of the user who created the songcast, when the songcast was created and/or published, and/or the number of media items in the songcast. In some embodiments, songcast story 406 may include a user-created annotation about the songcast as a whole. For example, songcast story 406 may include a text description of the media in the songcast, an image related to the songcast, and/or links to external information. In some embodiments, songcast story 406 may display a snippet of the full annotation (e.g., the first 40 characters of text) and interacting with songcast story 406 (e.g., clicking and/or tapping on songcast story 406) may display the full annotation.

In some embodiments, playback interface 408 may include a visual representation of the item of audio media that is currently playing and/or available to play, such as album art of a song. In one embodiment, playback interface 408 may also include various playback controls such as a pause and/or play button, a forward button, a back button, and/or any other relevant controls. In some examples, song story 410 may include information about the audio media item in playback interface 408 and/or a user-created annotation about the audio media item. For example, song story 410 may include the title of the media, creator of the media, and/or other relevant information about the media. In some examples, song story 410 may include a user-created annotation with further information and/or the user's feelings about the media. For example, a user may create an annotation for song story 410 that describes the first time the user heard the media, the impact the media has had on the user's life, titles of similar media items, and/or other information.

In one embodiment, feedback interface 412 may enable users who view the songcast to submit feedback, such as comments, on individual media items and/or the songcast as a whole. In some examples, feedback interface 412 may display comments left by users to the creator of the songcast. Additionally or alternatively, feedback interface 412 may display comments left by users to other users who view the songcast. In one embodiment, feedback interface 412 may include a sentiment widget 416 that enables users to express sentiments (e.g., “like,” “love,” etc.) about the media item. In some examples, expressing sentiment via sentiment widget 416 may generate social currency for the media item and/or songcast that may affect the ranking of the media item and/or songcast in popularity charts. In some embodiments, feedback interface 412 may include a media widget 418 that enables a user to view a media layer with additional information about the media item. In some embodiments, navigation interface 414 may include a sharing widget that enables a user to share the media item and/or songcast. Navigation interface 414 may also include a saving widget (not shown) that enables users to save the media item and/or songcast to their own media collection or media application or service. In one embodiment, navigation interface 414 may enable a user to navigate between media items in the songcast and/or between songcasts. In some examples, navigation interface 414 may display the current extent of a user's progress through an ordered list of media items in the songcast (e.g., via a progress bar).

Returning to FIG. 2, at step 210, one or more of the systems described herein may play, via the songcast display interface, the songcast for the additional user. For example, media module 108 may, as part of server 102 in FIG. 1, play, via songcast display interface 118, the songcast 112 for the additional user by playing at least one of audio media items 114 while simultaneously displaying user-created annotation 116.

Media module 108 may play the audio media item in a variety of ways and/or contexts. For example, media module 108 may play the audio media item in response to the additional user interacting with the playback interface. Additionally or alternatively, media module 108 may play the audio media item automatically when the previous audio media item in the songcast finishes playing.

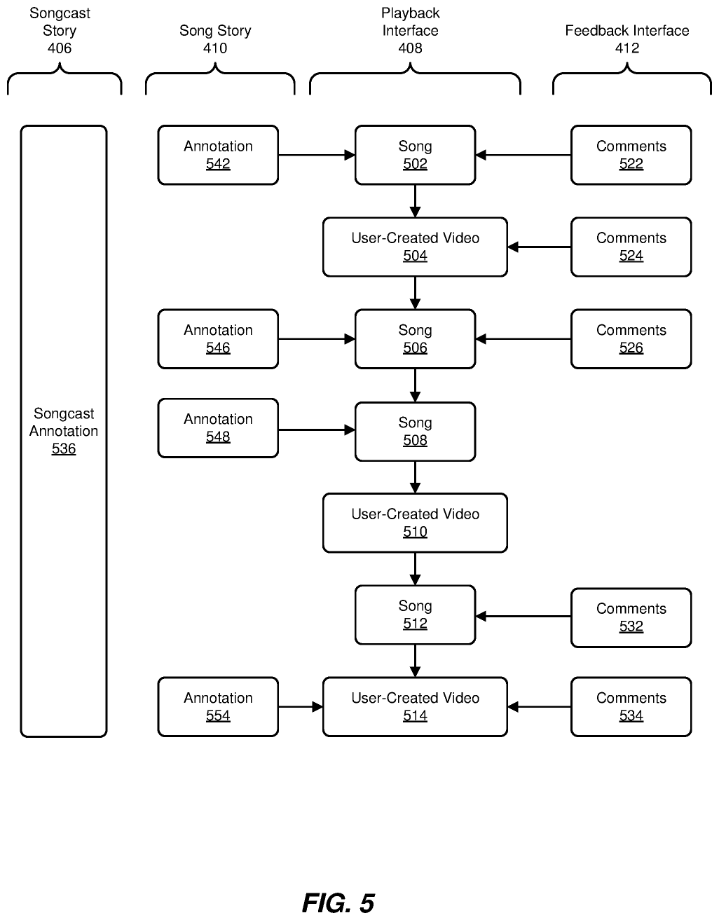

In some examples, different parts of the songcast display interface may change what is displayed when different items of audio media play. For example, as illustrated in FIG. 5, while a song 502 is playing in playback interface 408, playback interface 408 may display album cover art associated with song 502, feedback interface 412 may display comments 522 about song 502, song story 410 may display annotation 542 about song 502, and/or songcast story 406 may display songcast annotation 536. While the songcast display interface is playing a user-created video 504 via playback interface 408, feedback interface 412 may display comments 524 on user-created video 504. In some examples, song story 410 may not display an annotation if the user who created the songcast has not supplied an annotation for user-created video 504. In one embodiment, songcast story 406 may continue displaying songcast annotation 536 while any piece of media in the songcast, including user-created video 504, is playing. In some embodiments, songcast header 404 may not change between songs. In one example, while song 506 is playing, feedback interface 412 may display comments 526 on song 506 and/or song story 410 may display annotation 546 about song 506.

Similarly, while song a 508 is playing via playback interface 408, song story 410 may display annotation 548. If no user comments have been left on song 508, feedback interface 412 may not display any comments. If a user-created video 510 has neither comments nor annotations, feedback interface 412 and/or song story 410 may both have blank areas and/or display filler information and/or graphics. In one example, a song 512 may have comments 532 but no user-created annotation. In some examples, a user-created video 514 may have an annotation 554 and/or comments 534. In some embodiments, songcast story 406 may display songcast annotation 536 throughout all of the songs and/or user-created videos in the songcast.

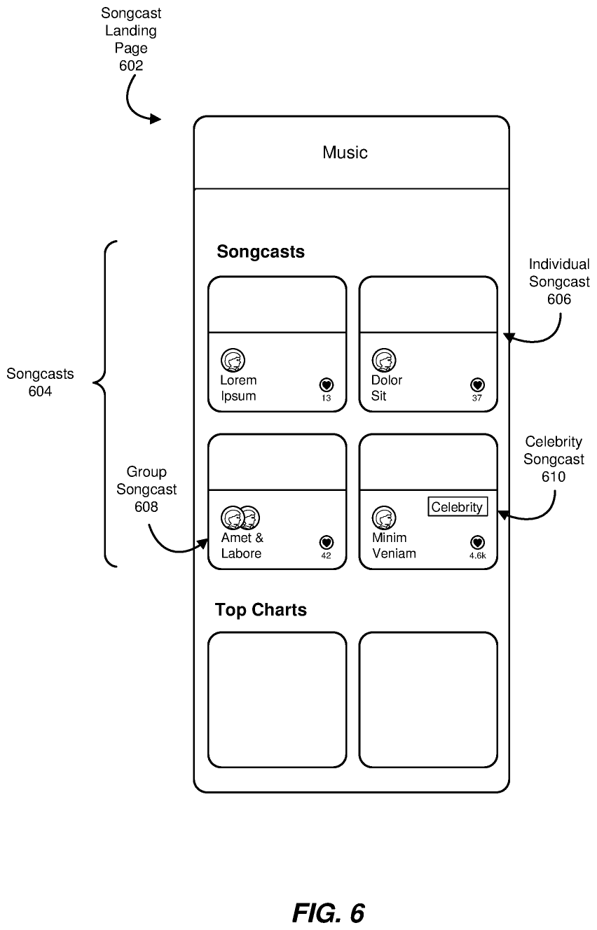

In some embodiments, the systems described herein may display a songcast landing page to a user that includes links to one or more songcasts. For example, as illustrated in FIG. 6, a songcast landing page 602 may include links to songcasts 604. In some embodiments, a songcast landing page may include links to different types of songcasts. For example, a songcast 606 may be an individual songcast created by an individual user. In another example, a group songcast 608 may be a songcast created by multiple users via separate user accounts and/or by multiple users via a single group account (e.g., for a performing group). In some embodiments, any creator of a group songcast may edit the songcast, view metrics for the songcast, view private comments on the songcast, and/or perform other administrative actions on the songcast.

In some examples, songcasts 604 may include a celebrity songcast 610 created by a special type of user account. In one embodiment, celebrity accounts may be accounts that are subject to an additional verification process to ensure that the owner of the account is correctly identified. In some embodiments, songcasts created by celebrity user accounts may be specially marked and/or function differently than songcasts created by individual users and/or groups. For example, all comments on a celebrity songcast may be public by default while comments on other types of songcasts may not necessarily be public.

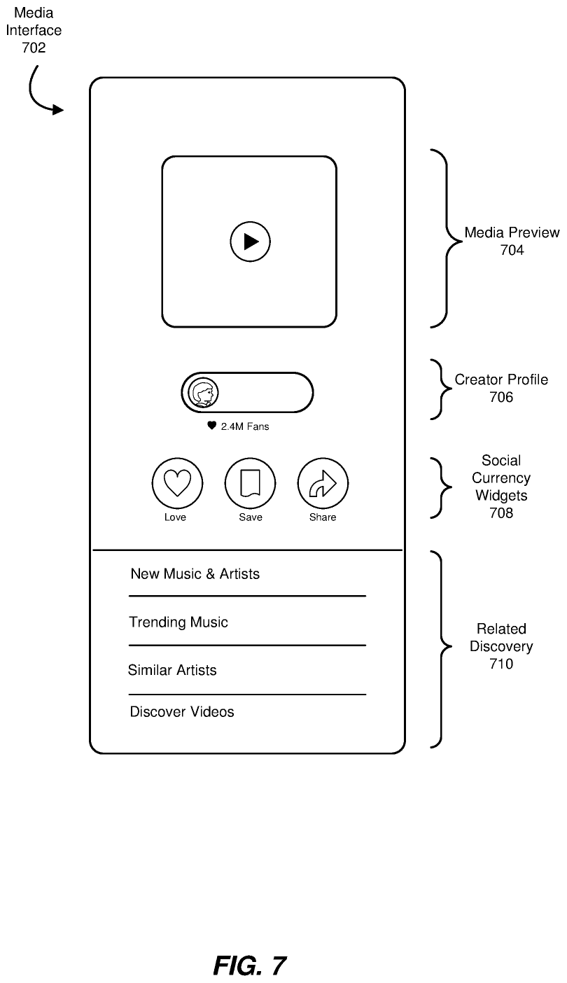

In some embodiments, interacting with a media widget displayed on a songcast may bring up a media interface layer that may include various types of information about and/or ways to interact with the audio media item. For example, as illustrated in FIG. 7, a media interface 702 may include a media preview 704 that may enable a user to view and/or listen to some or all of the audio media item, a creator profile 706 that may include information about one or more creators of the audio media item and/or a link to a creator profile page, social currency widgets 708 that may enable the user to perform various social-currency-generation actions on the audio media item (e.g., “liking,” “loving,” and/or “sharing” the audio media item), and/or related discovery 710 that may enable the user to discover items of media that are related to the audio media item. In some embodiments, related discovery 710 may enable a user to discover additional instances of the audio media item on the social networking platform, such as videos that feature the audio media item, posts that include the audio media item, additional songcasts that include the audio media item, and/or popularity charts that include the audio media item. In one embodiment, media interface 702 may display the same type of information in the same format regardless of the location from which a user accesses media interface 702. For example, the systems described herein may display media interface 702 to a user interacting with a media widget on a songcast, a media popularity chart, a link to an instance of the audio media item on another platform, and/or an instance of the audio media item embedded in another media item.

As described above, the systems and methods described herein may facilitate music and/or media discovery by users by enabling users to create and share songcasts that include lists of media items with user-supplied annotations. In some examples, the systems described herein may enable users to create themed songcasts to share with different audiences. In one example, the systems described herein may enable artists to create songcasts to promote their own music and the music of others. In some examples, by enabling users to comment on songcasts and media items within songcasts, the systems described herein may facilitate conversations about media and/or enable users to engage with one another and with media items.

### Example Embodiments

Example 1: A computer-implemented method may include (i) displaying, to a user, a songcast creation interface that enables the user to create a songcast, (ii) receiving, via the songcast creation interface, identification of a group of audio media items to be included in the songcast and at least one user-created annotation about the audio media items, (iii) creating the songcast in response to receiving the identification of the audio media items and the user-created annotation about the audio media items, (iv) displaying, via a songcast display interface, the songcast to an additional user, and (vi) playing, via the songcast display interface, the songcast for the additional user by playing at least one of the audio media items associated the songcast and simultaneously displaying the user-created annotation about the audio media items.

Example 2: The computer-implemented method of example 1, further including receiving, via the songcast creation interface, a selection of an audience of additional users who are permitted to view the songcast, displaying, via the songcast display interface, the songcast to at least one user in the audience of additional users who are permitted to view the songcast, and avoiding displaying the songcast to users not in the audience of additional users who are permitted to view the songcast.

Example 3: The computer-implemented method of examples 1 and 2, further including receiving, via the songcast creation interface, a media-specific user-created annotation about an audio media item within the songcast and simultaneously, via the songcast display interface, displaying the media-specific user-created annotation to the additional user while playing the audio media item.

Example 4: The computer-implemented method of examples 1-3, further including receiving, via the songcast creation interface, an item of user-created audio media to be included in the songcast and playing, via the songcast display interface, the item of user-created audio media.

Example 5: The computer-implemented method of examples 1-4, further including receiving, via the songcast display interface, from the additional user, a comment on an audio media item within the songcast and simultaneously, via the songcast display interface, displaying the comment while playing the audio media item for at least one user who is not the additional user.

Example 6: The computer-implemented method of examples 1-5, where receiving the references to the plurality of audio media items to be included in the songcast includes receiving an ordered list of the audio media items and playing at least one of the audio media items includes playing at least one of the audio media items in an order specified by the ordered list of the audio media items.

Example 7: The computer-implemented method of examples 1-6, further including displaying, via the songcast display interface, while playing the audio media item for the additional user, at least one of a sentiment widget that enables the additional user to express a sentiment about the audio media item, a sharing widget that enables the additional user to share the audio media item, a saving widget that enables the additional user to save the audio media item to a media collection for the additional user, or a media widget that opens a media interface page for the audio media item.

Example 8: A system including at least one physical processor and physical memory including computer-executable instructions that, when executed by the physical processor, cause the physical processor to (i) display, to a user, a songcast creation interface that enables the user to create a songcast, (ii) receive, via the songcast creation interface identification of a plurality of audio media items to be included in the songcast and at least one user-created annotation about the audio media items, (iii) create the songcast in response to receiving the identification of the plurality of audio media items and the user-created annotation about the audio media items, (iv) display, via a songcast display interface, the songcast to an additional user, and (v) play, via the songcast display interface, the songcast for the additional user by playing at least one of the audio media items associated the songcast and simultaneously displaying the user-created annotation about the audio media items.

Example 9: The system of example 8, where the computer-executable instructions cause the physical processor to receive, via the songcast creation interface, a selection of an audience of additional users who are permitted to view the songcast, display, via the songcast display interface, the songcast to at least one user in the audience of additional users who are permitted to view the songcast, and avoid displaying the songcast to users not in the audience of additional users who are permitted to view the songcast.

Example 10: The system of examples 8 and 9, where the computer-executable instructions cause the physical processor to receive, via the songcast creation interface, a media-specific user-created annotation about an audio media item within the songcast and simultaneously, via the songcast display interface, display the media-specific user-created annotation to the additional user while playing the audio media item.

Example 11: The system of examples 8-10, where the computer-executable instructions cause the physical processor to receive, via the songcast creation interface, an item of user-created audio media to be included in the songcast and play, via the songcast display interface, the item of user-created audio media.

Example 12: The system of examples 8-11, where the computer-executable instructions cause the physical processor to receive, via the songcast display interface, from the additional user, a comment on an audio media item within the songcast and simultaneously, via the songcast display interface, display the comment while playing the audio media item for at least one user who is not the additional user.

Example 13: The system of examples 8-12, where receiving the references to the plurality of audio media items to be included in the songcast includes receiving an ordered list of the audio media items and playing at least one of the audio media items includes playing at least one of the audio media items in an order specified by the ordered list of the audio media items.

Example 14: The system of examples 8-13, where the computer-executable instructions cause the physical processor to display, via the songcast display interface, while playing the audio media item for the additional user, at least one of a sentiment widget that enables the additional user to express a sentiment about the audio media item, a sharing widget that enables the additional user to share the audio media item, a saving widget that enables the additional user to save the audio media item to a media collection for the additional user, or a media widget that opens a media interface page for the audio media item.

Example 15: A non-transitory computer-readable medium including one or more computer-readable instructions that, when executed by at least one processor of a computing device, cause the computing device to (i) display, to a user, a songcast creation interface that enables the user to create a songcast, (ii) receive, via the songcast creation interface identification of a plurality of audio media items to be included in the songcast and at least one user-created annotation about the audio media items, (iii) create the songcast in response to receiving the identification of the plurality of audio media items and the user-created annotation about the audio media items, (iv) display, via a songcast display interface, the songcast to an additional user, and (v) play, via the songcast display interface, the songcast for the additional user by playing at least one of the audio media items associated the songcast and simultaneously displaying the user-created annotation about the audio media items.

Example 16: The non-transitory computer-readable medium of example 15, where the one or more computer-readable instructions cause the computing device to receive, via the songcast creation interface, a selection of an audience of additional users who are permitted to view the songcast, display, via the songcast display interface, the songcast to at least one user in the audience of additional users who are permitted to view the songcast, and avoid displaying the songcast to users not in the audience of additional users who are permitted to view the songcast.

Example 17: The non-transitory computer-readable medium of examples 15 and 16, where the one or more computer-readable instructions cause the computing device to receive, via the songcast creation interface, a media-specific user-created annotation about an audio media item within the songcast and simultaneously, via the songcast display interface, displaying the media-specific user-created annotation to the additional user while playing the audio media item.

Example 18: The non-transitory computer-readable medium of examples 15-17, where the one or more computer-readable instructions cause the computing device to receive, via the songcast creation interface, an item of user-created audio media to be included in the songcast and play, via the songcast display interface, the item of user-created audio media.

Example 19: The non-transitory computer-readable medium of examples 15-18, where the one or more computer-readable instructions cause the computing device to receive, via the songcast display interface, from the additional user, a comment on an audio media item within the songcast and simultaneously, via the songcast display interface, display the comment while playing the audio media item for at least one user who is not the additional user.

Example 20: The non-transitory computer-readable medium of examples 15-19, where the one or more computer-readable instructions cause the computing device to receive the references to the plurality of audio media items to be included in the songcast by receiving an ordered list of the audio media items and play at least one of the audio media items by playing at least one of the audio media items in an order specified by the ordered list of the audio media items.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
creating a group songcast authored by a group of users of a social networking platform by:
displaying, to each user in the group of users and via an interface of the social networking platform, a songcast creation interface that enables the group of users to create the group songcast and wherein the user accounts of each user in the group of users are allowed to perform administrative actions on the songcast;
receiving, via the songcast creation interface and from the group of users:
identification of a plurality of audio media items to be included in the songcast; and
at least one user-created annotation about the audio media items; and
creating the group songcast in association with the user accounts of each user in the group of users;
displaying, via a songcast display interface of the social networking platform, the group songcast to an additional user of the social networking platform in conjunction with a social currency widget that enables the additional user to perform social-currency generating actions on audio media items included in the group songcast; and
playing, via the songcast display interface, the group songcast for the additional user by:
playing at least one of the audio media items associated with the group songcast;
simultaneously displaying a related discovery section that enables the additional user to discover additional instances of the at least one of the audio media items on the social networking platform; and
simultaneously displaying the user-created annotation about the audio media items.

2. The computer-implemented method of claim 1, further comprising:
receiving, via the songcast creation interface, a selection of an audience of additional users who are permitted to view the group songcast;
displaying, via the songcast display interface, the group songcast to at least one user in the audience of additional users who are permitted to view the group songcast; and
avoiding displaying the group songcast to users not in the audience of additional users who are permitted to view the group songcast.

3. The computer-implemented method of claim 1, further comprising:
receiving, via the songcast creation interface, a media-specific user-created annotation about an audio media item within the group songcast; and
simultaneously displaying, via the songcast display interface, the media-specific user-created annotation to the additional user while playing the audio media item.

4. The computer-implemented method of claim 1, further comprising:
receiving, via the songcast creation interface, an item of user-created audio media to be included in the group songcast; and
playing, via the songcast display interface, the item of user-created audio media.

5. The computer-implemented method of claim 1, further comprising:
receiving, via the songcast display interface, from the additional user, a comment on an audio media item within the group songcast; and
simultaneously displaying, via the songcast display interface, the comment while playing the audio media item for at least one user who is not the additional user.

6. The computer-implemented method of claim 1, wherein:
receiving identification of the plurality of audio media items to be included in the group songcast comprises receiving an ordered list of the audio media items; and
playing at least one of the audio media items comprises playing at least one of the audio media items in an order specified by the ordered list of the audio media items.

7. The computer-implemented method of claim 1, further comprising displaying, via the songcast display interface, while playing the audio media item for the additional user, at least one of:
a sentiment widget that enables the additional user to express a sentiment about the audio media item;
a sharing widget that enables the additional user to share the audio media item;
a saving widget that enables the additional user to save the audio media item to a media collection for the additional user; or
a media widget that opens a media interface page for the audio media item.

8. A system comprising:
at least one physical processor;
physical memory comprising computer-executable instructions that, when executed by the physical processor, cause the physical processor to:
create a group songcast authored by a group of users of a social networking platform by:
displaying, to each user in the group of users and via an interface of the social networking platform, a songcast creation interface that enables the group of users to create the group songcast and wherein the user accounts of each user in the group of users are allowed to perform administrative actions on the songcast;
receiving, via the songcast creation interface and from the group of users:
identification of a plurality of audio media items to be included in the songcast; and
at least one user-created annotation about the audio media items; and
creating the group songcast in association with the user accounts of each user in the group of users;
display, via a songcast display interface of the social networking platform, the group songcast to an additional user of the social networking platform in conjunction with a social currency widget that enables the additional user to perform social-currency generating actions on audio media items included in the group songcast; and
play, via the songcast display interface, the group songcast for the additional user by:
playing at least one of the audio media items associated with the group songcast;
simultaneously displaying a related discovery section that enables the additional user to discover additional instances of the at least one of the audio media items on the social networking platform; and
simultaneously displaying the user-created annotation about the audio media items.

9. The system of claim 8, wherein the computer-executable instructions cause the physical processor to:
receive, via the songcast creation interface, a selection of an audience of additional users who are permitted to view the group songcast;
display, via the songcast display interface, the group songcast to at least one user in the audience of additional users who are permitted to view the group songcast; and
avoid displaying the group songcast to users not in the audience of additional users who are permitted to view the group songcast.

10. The system of claim 8, wherein the computer-executable instructions cause the physical processor to:
receive, via the songcast creation interface, a media-specific user-created annotation about an audio media item within the group songcast; and
simultaneously display, via the songcast display interface, the media-specific user-created annotation to the additional user while playing the audio media item.

11. The system of claim 8, wherein the computer-executable instructions cause the physical processor to:
receive, via the songcast creation interface, an item of user-created audio media to be included in the group songcast; and
play, via the songcast display interface, the item of user-created audio media.

12. The system of claim 8, wherein the computer-executable instructions cause the physical processor to:
receive, via the songcast display interface, from the additional user, a comment on an audio media item within the group songcast; and
simultaneously display, via the songcast display interface, the comment while playing the audio media item for at least one user who is not the additional user.

13. The system of claim 8, wherein:
receiving identification of the plurality of audio media items to be included in the group songcast comprises receiving an ordered list of the audio media items; and
playing at least one of the audio media items comprises playing at least one of the audio media items in an order specified by the ordered list of the audio media items.

14. The system of claim 8, wherein the computer-executable instructions cause the physical processor to display, via the songcast display interface, while playing the audio media item for the additional user, at least one of:
a sentiment widget that enables the additional user to express a sentiment about the audio media item;
a sharing widget that enables the additional user to share the audio media item;
a saving widget that enables the additional user to save the audio media item to a media collection for the additional user; or
a media widget that opens a media interface page for the audio media item.

15. A non-transitory computer-readable medium comprising one or more computer-readable instructions that, when executed by at least one processor of a computing device, cause the computing device to:
create a group songcast authored by a group of users of a social networking platform by:
displaying, to each user in the group of users and via an interface of the social networking platform, a songcast creation interface that enables the group of users to create the group songcast and wherein the user accounts of each user in the group of users are allowed to perform administrative actions on the songcast;
receiving, via the songcast creation interface and from the group of users:
identification of a plurality of audio media items to be included in the songcast; and
at least one user-created annotation about the audio media items; and
creating the group songcast in association with the user accounts of each user in the group of users;
display, via a songcast display interface of the social networking platform, the group songcast to an additional user of the social networking platform in conjunction with a social currency widget that enables the additional user to perform social-currency generating actions on audio media items included in the group songcast; and
play, via the songcast display interface, the group songcast for the additional user by:
playing at least one of the audio media items associated with the group songcast;
simultaneously displaying a related discovery section that enables the additional user to discover additional instances of the at least one of the audio media items on the social networking platform; and
simultaneously displaying the user-created annotation about the audio media items.

16. The non-transitory computer-readable medium of claim 15, wherein the one or more computer-readable instructions cause the computing device to:
receive, via the songcast creation interface, a selection of an audience of additional users who are permitted to view the group songcast;
display, via the songcast display interface, the group songcast to at least one user in the audience of additional users who are permitted to view the group songcast; and
avoid displaying the group songcast to users not in the audience of additional users who are permitted to view the group songcast.

17. The non-transitory computer-readable medium of claim 15, wherein the one or more computer-readable instructions cause the computing device to:
receive, via the songcast creation interface, a media-specific user-created annotation about an audio media item within the group songcast; and
simultaneously display, via the songcast display interface, the media-specific user-created annotation to the additional user while playing the audio media item.

18. The non-transitory computer-readable medium of claim 15, wherein the one or more computer-readable instructions cause the computing device to:
receive, via the songcast creation interface, an item of user-created audio media to be included in the group songcast; and
play, via the songcast display interface, the item of user-created audio media.

19. The non-transitory computer-readable medium of claim 15, wherein the one or more computer-readable instructions cause the computing device to:
receive, via the songcast display interface, from the additional user, a comment on an audio media item within the group songcast; and
simultaneously display, via the songcast display interface, the comment while playing the audio media item for at least one user who is not the additional user.

20. The non-transitory computer-readable medium of claim 15, wherein the one or more computer-readable instructions cause the computing device to:
receive identification of the plurality of audio media items to be included in the group songcast by receiving an ordered list of the audio media items; and
play at least one of the audio media items by playing at least one of the audio media items in an order specified by the ordered list of the audio media items.
